(19) United States
(12) Patent Application Publication
(10) Pub. No.: US 2012/0050942 A1
(43) Pub. Date: Mar. 1, 2012

(54) Electrochemical capacitor

(75) Inventors: Hak Kwan Kim, Hanam-si (KR); Bae Kyun Kim, Seongnam-si (KR); Hong Seok Min, Yongin-si (KR); Dong Hyeok Choi, Suwon-si (KR)

(73) Assignee: SAMSUNG ELECTRO-MECHANICS CO., LTD., Suwon (KR)

(21) Appl. No.: 13/137,544

(22) Filed: Aug. 24, 2011

(30) Foreign Application Priority Data
Aug. 27, 2010 (KR) 10-2010-0083380

(51) Int. Cl. H01G 9/00

(52) U.S. Cl. 361/500

(57) ABSTRACT

Provided is an electrochemical capacitor including an electrolyte, an electrode cell immersed in the electrolyte, and including first and second electrodes alternately laminated with separators interposed therebetween, a housing in which the electrolyte and the electrode cell are contained, and a hydrofluoric acid adsorption member for adsorbing hydrofluoric acid (HF) applied on at least a portion of an inner surface of the housing.

### CROSS-REFERENCE TO RELATED APPLICATIONS

This application claims the benefit of Korean Patent Application No. 10-2010-0083380 filed with the Korea Intellectual Property Office on Aug. 27, 2010, the disclosure of which is incorporated herein by reference.

### BACKGROUND OF THE INVENTION

1. Field of the Invention

The present invention relates to an electrochemical capacitor, and more particularly, to an electrochemical capacitor including an adsorption member for removing an unnecessary gas in a housing.

2. Description of the Related Art

Electrochemical capacitors have been attracting attention as high quality energy sources in a renewable energy system that can be applied to electric vehicles, hybrid vehicles, fuel cell vehicles, heavy equipment, mobile electronic terminals, and so on. Such electrochemical capacitors are referred to as various names such as supercapacitors and ultra capacitors.

Such an electrochemical capacitor may include an electrode cell immersed in an electrolyte, and a housing in which the electrolyte and the electrode cell are sealed. The electrode cell may include cathodes and anodes alternately laminated with separators interposed therebetween.

Here, the electrolyte includes an electrolytic material formed of lithium salts. In particular, when LiBF₄ having high ion conductivity among lithium salts is used, reaction of LiBF₄ and moisture may generate hydrofluoric acid. Here, the hydrofluoric acid may be formed through various reactions of a material that forms an electrochemical capacitor.

Such hydrofluoric acid may corrode a current collector or a housing installed at the cathode and the anode. In addition, the hydrofluoric acid may act as a catalyst to decompose solvent of the electrolyte. Accordingly, the hydrofluoric acid may decrease performance and reliability of the electrochemical capacitor.

As a result, the conventional electrochemical capacitor may be decreased in performance and reliability due to generation of hydrofluoric gas.

### SUMMARY OF THE INVENTION

The present invention has been invented in order to overcome the above-described problems and it is, therefore, an object of the present invention to provide an electrochemical capacitor including an adsorption member for removing an unnecessary gas in a housing to prevent decrease in performance and reliability.

In accordance with one aspect of the present invention to achieve the object, there is provided an electrochemical capacitor including: an electrolyte; an electrode cell immersed in the electrolyte, and including first and second electrodes alternately laminated with separators interposed therebetween; a housing in which the electrolyte and the electrode cell are contained; and a hydrofluoric acid adsorption member for adsorbing hydrofluoric acid (HF) applied on at least a portion of an inner surface of the housing.

Here, the hydrofluoric acid adsorption member may be formed of any one of lithium, carbonate, and polyamide-based compound.

In addition, the carbonate may include at least one of Li₂CO₃, Na₂CO₃ and K₂CO³.

Further, the electrochemical capacitor may further include a hydrogen adsorption member disposed on at least a portion of the inner surface of the housing and adsorbing hydrogen gas in the housing.

Furthermore, the hydrogen adsorption member may be disposed on the hydrofluoric acid adsorption member.

In addition, the hydrogen adsorption member is formed of a porous thin film.

Further, the hydrogen adsorption member may be formed of Li₂NH or Li₃N.

Furthermore, the housing may be formed of any one of a metal laminated film and a metal can.

In accordance with another aspect of the present invention to achieve the object, there is provided an electrochemical capacitor including: an electrolyte; an electrode cell immersed in the electrolyte and including first and second electrodes alternately laminated with separators interposed therebetween; a hydrofluoric acid adsorption member disposed on at least a portion of an inner surface of the housing and adsorbing hydrofluoric acid (HF); and a hydrogen adsorption member disposed on the hydrofluoric acid adsorption member.

Here, the hydrofluoric acid adsorption member may be formed of lithium and the hydrogen adsorption member is formed of Li₃N.

In addition, the hydrogen adsorption member may be formed of a porous thin film.

Further, the housing may be formed of any one of a metal laminated film and a metal can.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a lithium ion capacitor in accordance with an exemplary embodiment of the present invention;

FIG. 2 is an assembled perspective view of the lithium ion capacitor in accordance with an exemplary embodiment of the present invention;

FIG. 3 is a cross-sectional view taken along line I-I′ shown in FIG. 2; and

FIG. 4 is an enlarged cross-sectional view of a region A shown in FIG. 3.

### DETAILED DESCRIPTION OF THE PREFERABLE EMBODIMENTS

Hereinafter, embodiments of the present invention for a lithium ion capacitor will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

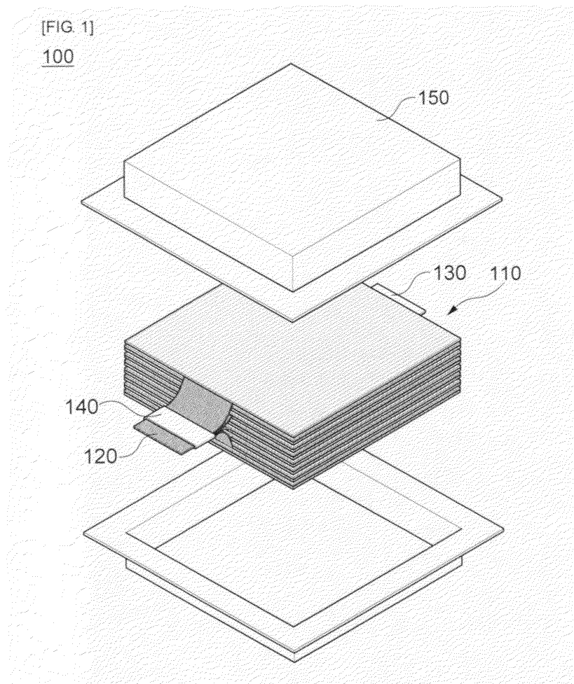

FIG. 1 is an exploded perspective view of a lithium ion capacitor in accordance with an exemplary embodiment of the present invention.

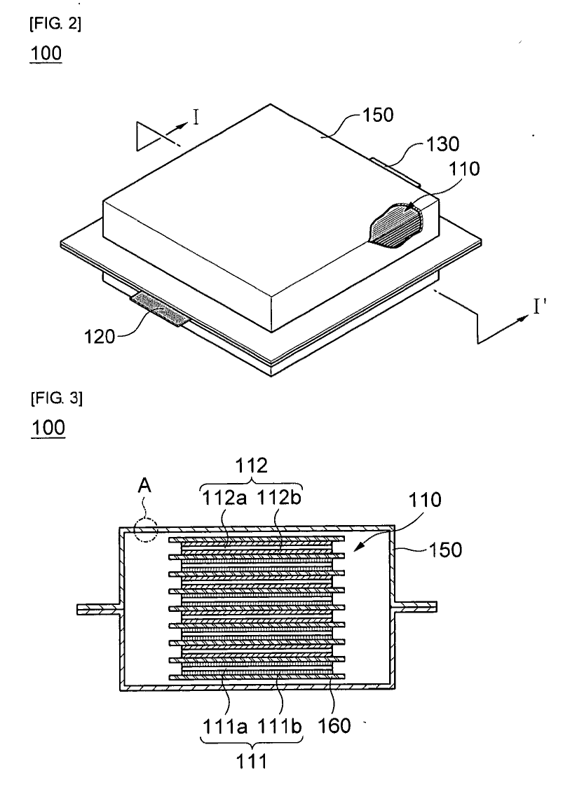

FIG. 2 is an assembled perspective view of the lithium ion capacitor in accordance with an exemplary embodiment of the present invention.

FIG. 3 is a cross-sectional view taken along line I-I′ shown in FIG. 2.

Referring to FIGS. 1 to 3, a lithium ion capacitor 100 in accordance with an exemplary embodiment of the present invention may include an electrode cell 110, an electrolyte, and a housing 150.

Here, the electrode cell 110 may include first and second electrodes 111 and 112 alternately laminated with separators 160 interposed therebetween.

The separators 160 may act to electrically separate the first and second electrodes 111 and 112 from each other. While the separator 150 may be formed of paper or non-woven fabric, the embodiment of the present invention is not limited to the kind of the separator 150.

The first electrode 111 may include a first current collector 111a, and first active material layers 111b disposed at both surfaces of the first current collector 111a.

For example, the first electrode 111 may be a cathode. At this time, the first current collector 111a may be formed of any one of aluminum, stainless steel, copper, nickel, titanium, tantalum, and niobium.

The first current collector 111a may have a thin film shape, or the first current collector 111a may include a plurality of through-holes to effectively perform migration of ions and a uniform doping process.

In addition, the first active material layer 111b may include a carbon material to which ions can be reversibly doped and undoped, i.e., activated carbon.

Further, the first active material layer 111 b may include a binder. Here, the binder may be formed of one or two or more selected from fluoride-based resin such as polytetrafluoroethylene (PTFE), polyvinylidene fluoride (PVdF), and so on, thermosetting resin such as polyimide, polyamidoimide, polyethylene (PE), polypropylene (PP), and so on, cellulose-based resin such as carboximethyl cellulose (CMC), and so on, rubber-based resin such as stylenebutadiene rubber (SBR), and so on, ethylenepropylenediene monomer (EPDM), polydimethylsiloxane (PDMS), polyvinyl pyrrolidone (PVP), and so on.

In addition, the first active material layer 111b may further include a conductive material, for example, carbon black, a solvent, and so on.

The second electrode 112 may include a second current collector 112a, and second active material layers 112b disposed on both surfaces of the second current collector 112a.

For example, the second electrode may be an anode. Here, the first current collector 112a may be formed of any one metal, for example, selected from copper, nickel and stainless steel. The first current collector 112a may have a thin film shape, or the first current collector 112a may include a plurality of through-holes to effectively perform migration of ions and a uniform doping process.

In addition, the first active material layer 112b may include a carbon material to which ions can be reversibly doped and undoped, for example, graphite or activated carbon. Here, when the electrochemical capacitor is a lithium ion capacitor, the first active material layer 112b may be graphite pre-doped with lithium ions.

Therefore, since a potential of the second electrode 112 can be lowered to a potential of lithium, i.e., about 0V, energy density of the lithium ion capacitor can be increased. At this time, the potential of the second electrode 112 may be adjusted by controlling a pre-doping process of the lithium ion.

In addition, the first electrode 111 may include a first terminal 120 to be connected to an external power supply. The first terminal 120 may extend from one side of the first current collector 111a.

When the plurality of first electrodes 111 are laminated in the electrode cell 110, the first terminals 120 extending from the first electrodes 111 may also be laminated. At this time, in order to be connected to the exterior, the laminated first terminals 120 may be fused to be integrated.

The fused first terminals 120 may be in direct contact with the external power supply. Otherwise, the fused first terminals 120 may be bonded to a separated external terminal to be connected to the external power supply through the external terminal.

In addition, the second electrode 112 may include a second terminal 130 to be connected to the external power supply. At this time, the second terminal 130 may extend from one side of the second current collector 112a. Here, the plurality of second terminals 120 may be fused to be integrated. Here, the fused second terminals 130 may be directly connected to an external power supply, or may be bonded to the external terminal to be connected to the external power supply through the external terminal.

Further, insulating members 140 may be further installed at the first and second terminals 120 and 130 or upper and lower parts of the external terminal. The insulating members 140 may function to insulate the first and second terminals 120 and 130 or the external terminal from the housing 150, which is to be described.

While this embodiment of the present invention has shown and described the electrode cell 110 as a pouch type, the electrode cell 110 may be a wound type in which the first and second electrodes 111 and 112 and the separator are wound in a roll shape.

Here, the electrode cell 110 is immersed in the electrolyte. At this time, the first and second active material layers 111b and 112b and the separator 160 may be immersed in the electrolyte.

The electrolyte may function as a medium for migration of lithium ions, and may include an electrolyte and solvent. Here, the electrolyte may be a salt, for example, lithium salt or ammonium salt. At this time, the lithium salt may be LiPF₆, LiBF₄, LiClO₄, and so on.

The solvent may be selected in consideration of solubility of the electrolyte, reaction performance with the electrode, viscosity and a usable temperature range. The solvent may use a non-proton organic solvent. The solvent may be, for example, propylene carbonate, diethyl carbonate, ethylene carbonate, sulfolane, acetone nitrile, demethoxy ethane, tetrahydrofuran, ethylmethyl carbonate, and so on. Here, the solvent may be used by mixing one or two or more.

The housing 150 may be formed by thermal-bonding two sheets of metal laminated films. For another example, the housing 150 may be formed of a metal can.

The housing 150 may be formed of various types such as a cylinder type or a prismatic type. However, the housing may have a different shape from that of the electrode cell 110, rather than the shape corresponding to the electrode cell 110.

The housing 150 may further include an adsorption member installed at an inner surface thereof and adsorbing a gas that decreases performance or lifespan of the electrochemical capacitor 100.

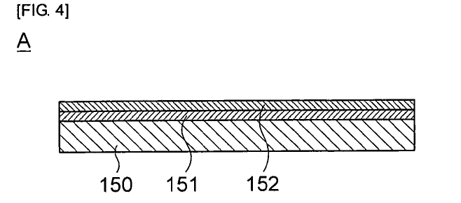

Hereinafter, a housing of the present invention will be described with reference to FIG. 4 in detail.

FIG. 4 is an enlarged cross-sectional view of a region A shown in FIG. 3.

Referring to FIG. 4, a hydrofluoric acid adsorption member 151 may be disposed on at least a portion of the inner surface of the housing 150 to adsorb hydrofluoric acid.

The hydrofluoric acid may be adsorbed to the hydrofluoric acid adsorption member 151 to be removed from the housing 150. Here, the hydrofluoric acid adsorption member 151 may be formed of a material that can chemically react with hydrofluoric acid to adsorb the hydrofluoric acid, for example, any one of lithium, carbonate, and polyamide-based compound. The carbonate may be, for example, at least one of Li₂CO₃, Na₂CO₃ and K₂CO₃.

Here, the hydrofluoric acid adsorption member 151 may be a thin film formed by a sputtering method, an electron beam evaporation method, a chemical vapor deposition method, a thermal evaporation method, a plasma chemical vapor deposition method, and so on. Accordingly, the hydrofluoric acid adsorption member 151 may be attached to the inner surface of the housing 150 without a separate adhesive agent.

Meanwhile, hydrofluoric acid adsorption to the hydrofluoric acid adsorption member 151 may be performed through the following chemical reaction formula 1. Here, the case that the hydrofluoric acid adsorption member 151 is formed of lithium will be exemplarily described.

<Formula 1>

HF+Li→LiF+1/2H₂

As described in the formula 1, hydrofluoric acid reacts with lithium to form lithium fluoride so that the hydrofluoric acid can be removed from the housing 150.

However, byproducts such as hydrogen gas may be generated during a process of adsorbing the hydrofluoric acid using the hydrofluoric acid adsorption member 152. The hydrogen gas may increase an internal resistance or capacitance of the electrochemical capacitor 100. In addition, the hydrogen gas may be formed by decomposition of the electrolyte.

In order to solve the problems, a hydrogen adsorption member 152 may be further disposed on at least a portion of the inner surface of the housing 150 to absorb hydrogen gas.

The hydrogen adsorption member 152 may be disposed on the hydrofluoric acid adsorption member 152. Here, in order not to disturb movement of hydrofluoric acid to the hydrofluoric acid adsorption member 151, the hydrogen adsorption member 152 may be formed of a porous thin film.

The hydrogen adsorption member 152 may be formed of a material than can chemically react with hydrogen to adsorb the hydrogen, for example, Li₂NH or Li₃N. Here, the hydrogen adsorption member 152 may be formed by a sputtering method, an electron beam evaporation method, a chemical vapor deposition method, a thermal evaporation method, a plasma chemical vapor deposition method, and so on. In particular, when the hydrogen adsorption member 152 is formed of Li₂NH, the hydrogen adsorption member 152 may be formed by a hydrogen storage alloy method.

In addition, when the hydrofluoric acid adsorption member 151 is formed of lithium, the hydrogen adsorption member 152 may be formed of Li₃N. This is because, when the hydrogen adsorption member 152 is formed of Li₃N, the hydrogen adsorption member 152 can be easily and naturally formed in the atmosphere due to strong reaction with nitrogen after forming a lithium layer, without specific surface treatment. That is, in order to form the hydrogen adsorption member 152, first, the hydrofluoric acid adsorption member 151 is formed. Next, as the hydrofluoric acid adsorption member 151 is exposed to the atmosphere, the porous hydrogen adsorption member 152 may be naturally formed on the surface of the hydrofluoric acid adsorption member 152. In addition, the hydrogen adsorption member 152 may be formed by forming the hydrofluoric acid adsorption member 151 and then providing a separate nitrogen gas onto the surface of the hydrofluoric acid adsorption member 151.

Therefore, the porous hydrogen adsorption member 152 may be easily formed by forming a lithium thin film as the hydrofluoric acid adsorption member 151 through a deposition process and then exposing the lithium thin film under the normal atmosphere or providing a separate nitrogen gas, reducing manufacturing cost.

Meanwhile, hydrogen adsorption to the hydrogen adsorption member 152 may be performed by the following chemical formula 1.

### <Formula 2>

Li₃N+H₂→Li₂NH+LiH

<Formula 3>

Li₂NH+H₂→LiNH₂+LiH

As described in the formulae 2 and 3, the hydrogen may chemically react with Li₃N or Li₂NH to be removed from the housing 150, without generating a separate gas.

While it has been described in the embodiment of the present invention that the hydrofluoric acid adsorption member 151 and the hydrogen adsorption member 152 are formed in a laminated structure, the structure is not limited thereto. For example, the hydrofluoric acid adsorption member 151 and the hydrogen adsorption member 152 may be parallelly arranged on the inner surface of the housing.

In addition, the hydrofluoric acid adsorption member 151 may be formed on the entire inner surface of the housing 150, or may be formed on a portion of the inner surface of the housing 150.

Therefore, as described in the embodiment of the present invention, the hydrofluoric acid adsorption member may be disposed in the housing to prevent decrease in performance and reliability of the electrochemical capacitor due to hydrofluoric acid.

Further, the hydrogen adsorption member may be further provided in the housing to remove byproducts such as hydrogen gas, which may be generated due to the hydrofluoric acid adsorption to the hydrofluoric acid adsorption member, preventing increase in internal resistance and increase in capacitance of the electrochemical capacitor.

As can be seen from the foregoing, the electrochemical capacitor in accordance with an exemplary embodiment of the present invention may include the hydrofluoric acid adsorption member provided in the housing to prevent decrease in performance and reliability of the electrochemical capacitor due to hydrofluoric acid.

In addition, the electrochemical capacitor in accordance with an exemplary embodiment of the present invention may further include the hydrogen adsorption member to remove byproducts such as hydrogen gas, which may be generated due to the hydrofluoric acid adsorption to the hydrofluoric acid adsorption member, preventing increase in internal resistance and increase in capacitance of the electrochemical capacitor.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An electrochemical capacitor comprising:
an electrolyte;
an electrode cell immersed in the electrolyte, and including first and second electrodes alternately laminated with separators interposed therebetween;
a housing in which the electrolyte and the electrode cell are contained; and
a hydrofluoric acid adsorption member for adsorbing hydrofluoric acid (HF) applied on at least a portion of an inner surface of the housing.

2. The electrochemical capacitor according to claim 1, wherein the hydrofluoric acid adsorption member is formed of any one of lithium, carbonate, and polyamide-based compound.

3. The electrochemical capacitor according to claim 1, wherein the carbonate comprises at least one of Li₂CO₃, Na₂CO₃ and K₂CO³.

4. The electrochemical capacitor according to claim 1, further comprising a hydrogen adsorption member disposed on at least a portion of the inner surface of the housing and adsorbing hydrogen gas in the housing.

5. The electrochemical capacitor according to claim 4, wherein the hydrogen adsorption member is disposed on the hydrofluoric acid adsorption member.

6. The electrochemical capacitor according to claim 5, wherein the hydrogen adsorption member is formed of a porous thin film.

7. The electrochemical capacitor according to claim 4, wherein the hydrogen adsorption member is formed of Li₂NH or Li₃N.

8. The electrochemical capacitor according to claim 1, wherein the housing is formed of any one of a metal laminated film and a metal can.

9. An electrochemical capacitor comprising:
an electrolyte;
an electrode cell immersed in the electrolyte and including first and second electrodes alternately laminated with separators interposed therebetween;
a hydrofluoric acid adsorption member disposed on at least a portion of an inner surface of the housing and adsorbing hydrofluoric acid (HF); and
a hydrogen adsorption member disposed on the hydrofluoric acid adsorption member.

10. The electrochemical capacitor according to claim 9, wherein the hydrofluoric acid adsorption member is formed of lithium and the hydrogen adsorption member is formed of Li₃N.

11. The electrochemical capacitor according to claim 10, wherein the hydrogen adsorption member is formed of a porous thin film.

12. The electrochemical capacitor according to claim 9, wherein the housing is formed of any one of a metal laminated film and a metal can.
